(19) United States
(12) Patent Application Publication
(10) Pub. No.: US 2020/0359814 A1
(43) Pub. Date: Nov. 19, 2020

(54) Breathable Bed Cover

(71) Applicant: Enfant Terrible Design AB, Norrtälje (SE)

(72) Inventors: Peter J Myers, Wheaton, IL (US); Alice M. Marks, Wheaton, IL (US)

(73) Assignee: Enfant Terrible Design AB, Norrtälje (SE)

(21) Appl. No.: 16/762,178

(22) PCT Filed: Nov. 14, 2018
(86) PCT No.: PCT/IB2018/058978

§ 371 Date: May 7, 2020

Related U.S. Application Data
(60) Provisional application No. 62/585,924, filed on Nov. 14, 2017.

(51) Int. Cl. A47G 9/04; B32B 5/02; B32B 3/00; B32B 5/26; A47C 21/02; A47D 15/02

(52) U.S. Cl. CPC A47G 9/04; B32B 5/024; B32B 3/00; B32B 5/26; B32B 2479/00; A47D 15/02; B32B 2307/724; B32B 2262/0215; B32B 2262/0276; A47C 21/02

(57) ABSTRACT

A breathable bed cover includes a breathable fabric layer, an air-permeable cushioning layer, and a bed-attachment mechanism. The breathable fabric layer is superimposed across the air-permeable cushioning layer. The breathable fabric layer and the air-permeable cushioning layer are positioned coextensive with each other. The bed-attachment mechanism is perimetrically connected around the air-permeable cushioning layer. Resultantly, the breathable fabric layer and air-permeable cushioning layer can be attached to a bassinet mattress or a crib mattress through the bed-attachment mechanism.

### FIELD OF THE INVENTION

The present invention relates generally to a mattress fitted sheet. More specifically, the present invention is a fitted sheet for infant mattresses that allows improved breathability for the baby/user.

### BACKGROUND OF THE INVENTION

It is well known that there is an inherent danger in allowing a newborn baby to sleep facing down, as this causes a situation in which the baby may have trouble breathing due to having their nose and mouth pressed against the solid surface of a crib or bassinet mattress or the fitted sheet over these mattresses. Doctors currently recommend babies sleep on their backs to avoid this situation, but it is impossible to control babies that might roll over while the parent is not awake or watching.

Several crib mattresses have been developed to create breathable surfaces to address this issue, but they are both expensive and limited in their effectiveness, as covering them with a standard fitted sheet renders them ineffective. The present invention is a fitted sheet device for infant crib or bassinet mattresses. The present invention offers improved ability for the baby to breathe through the invention's arranged layers of fabric.

### BRIEF DESCRIPTION OF THE DRAWINGS

FIG. 1 is a top view of the present invention shown around the bassinet mattress.

FIG. 2 is a top view of the present invention shown around the crib mattress.

FIG. 3 is a side view of the present invention, wherein the present invention covers the crib mattress.

FIG. 4 is a side exploded view of the present invention, wherein the present invention is separated from the crib mattress.

FIG. 5 is a detailed view of the present invention, showing the components of the bed-attachment mechanism.

FIG. 6 is a side view of the present invention, wherein the present invention covers the bassinet mattress.

FIG. 7 is a side exploded view of the present invention, wherein the present invention is separated from the bassinet mattress.

FIG. 9 is a multiple perspective view of the breathable sheet invention and its mesh layer components.

FIG. 10 is a sample drawing of the present invention in two preferred embodiments: fitted bassinet sheet and fitted crib sheet.

FIG. 11 is an exploded view of the present invention and its multiple layers in a preferred embodiment.

FIG. 12 is a sample drawing of the present invention in use with a crib mattress.

FIG. 13 is a sample drawing of the present invention in use with a bassinet mattress.

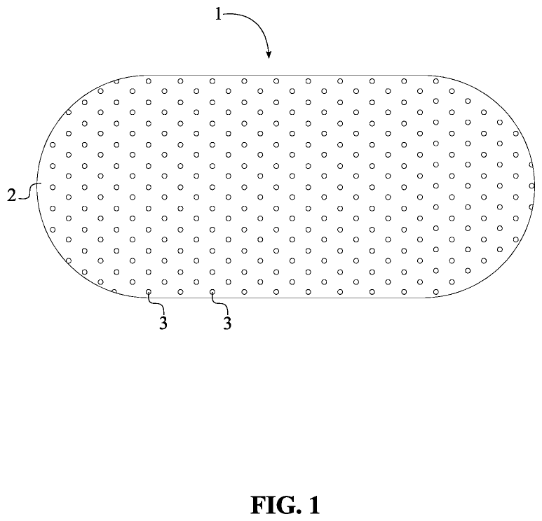

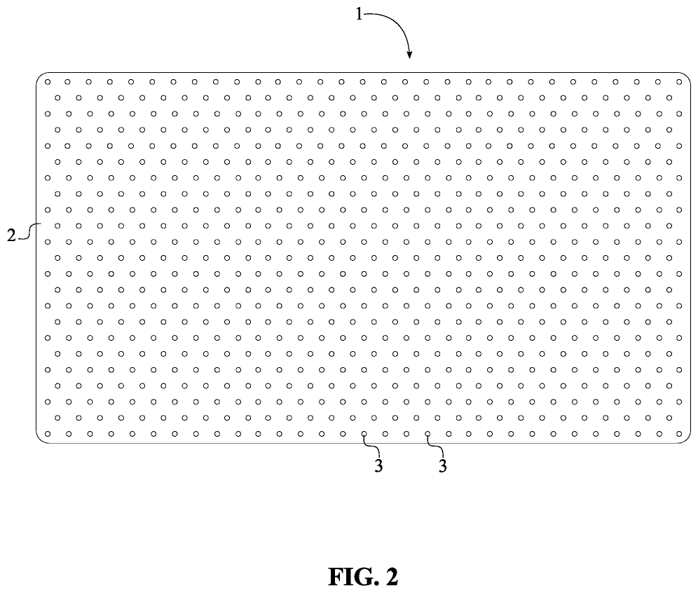

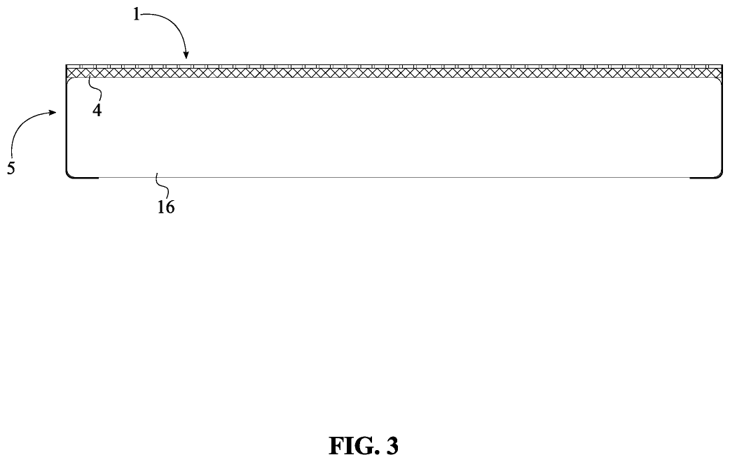

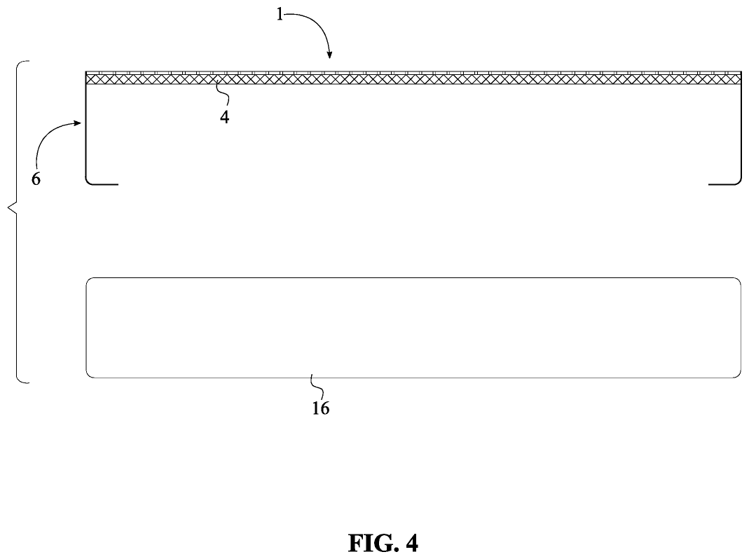

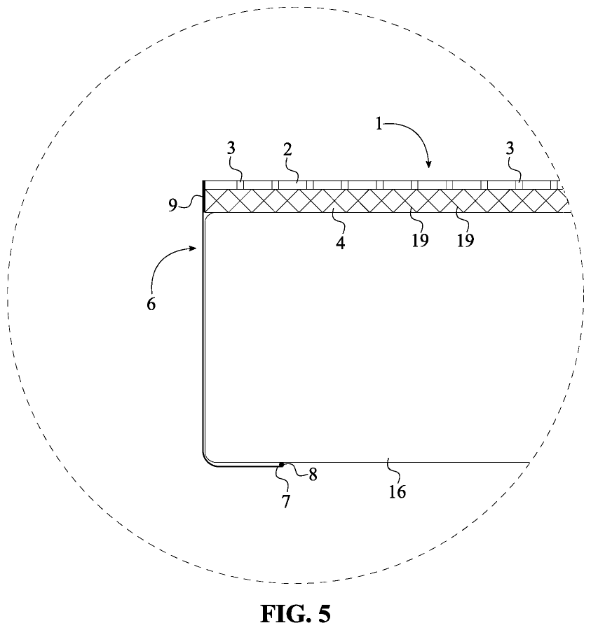

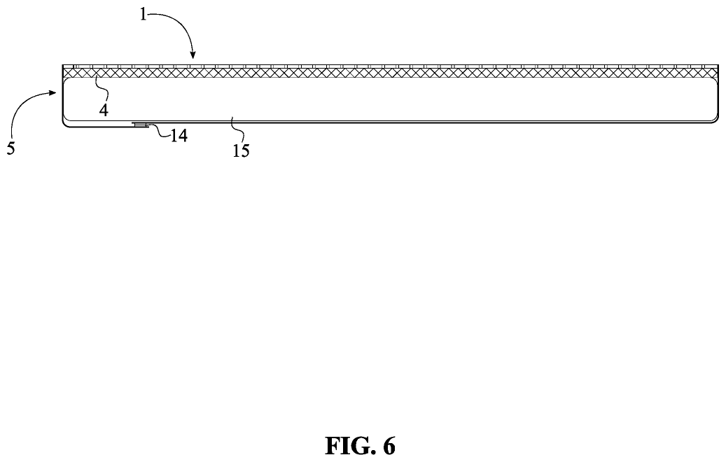

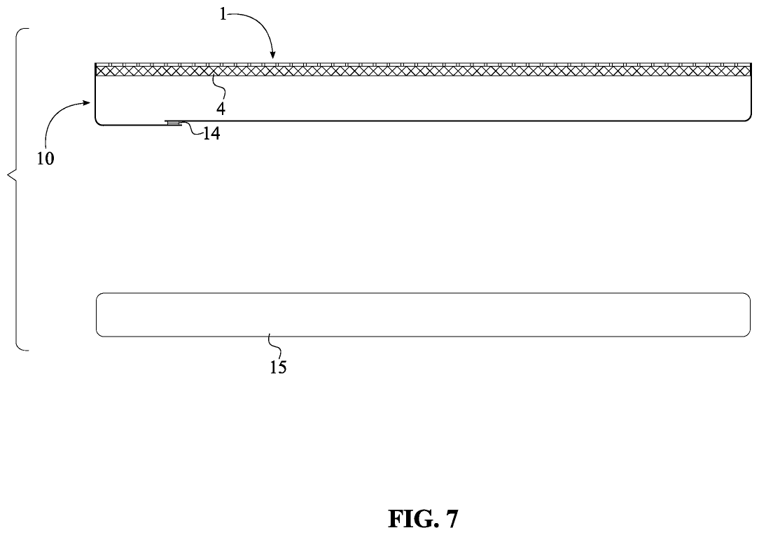

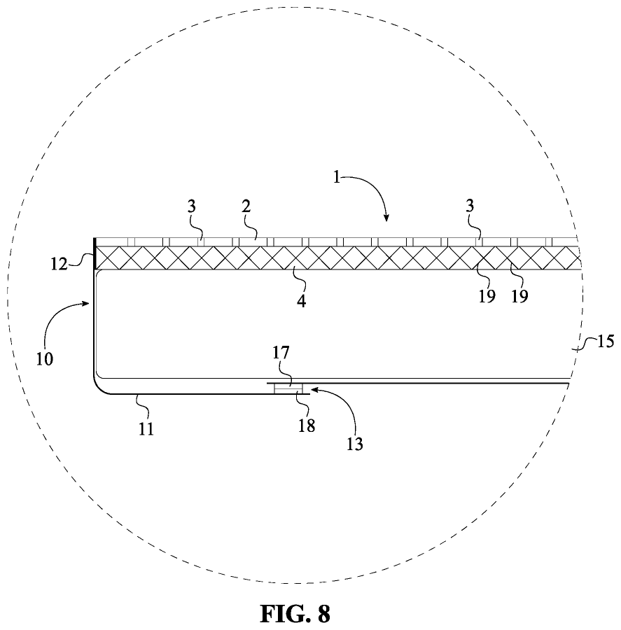

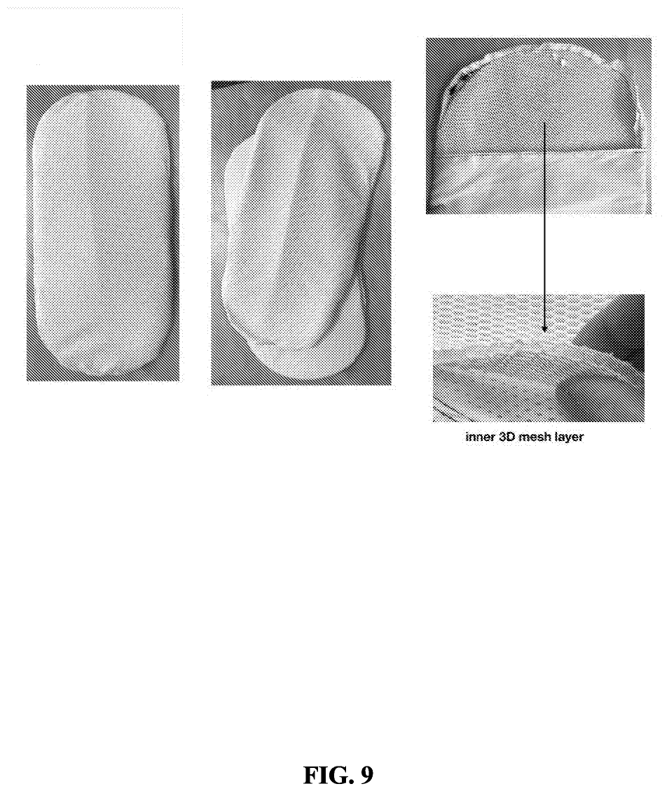

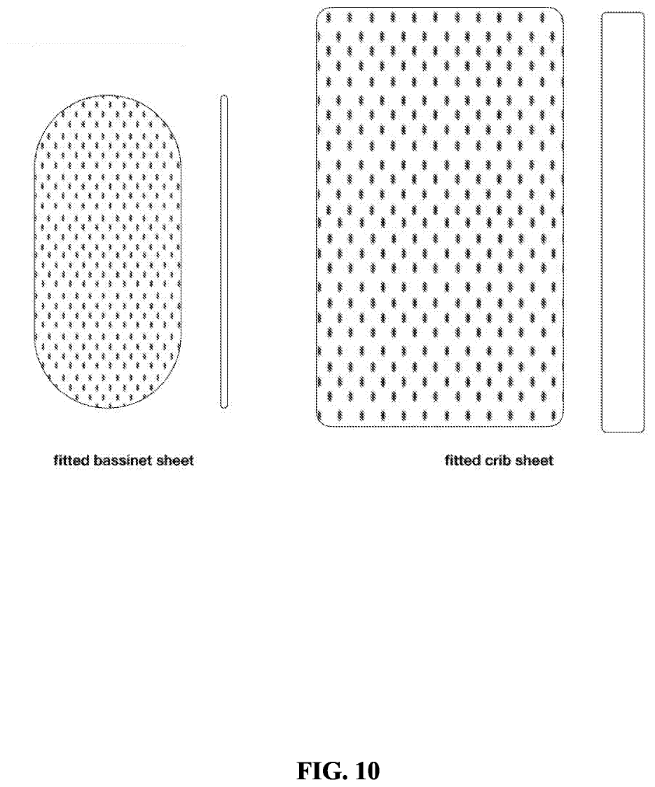

### DETAIL DESCRIPTIONS OF THE INVENTION

All illustrations of the drawings are for the purpose of describing selected versions of the present invention and are not intended to limit the scope of the present invention.

The present invention is a breathable bed cover that allows a baby to breathe through the present invention, if the baby is lying face down on a mattress, and if the present invention is enclosing the mattress. The present invention can be attached to the following: a crib mattress for babies and toddlers; a smaller mattress for bassinets, cradles, moses baskets, and strollers; a larger mattress for adults (twin, full, queen, king, etc.); and any other sleeping surface (futon, bedroll, etc.). The present invention comprises a breathable fabric layer, an air-permeable cushioning layer, and a bed-attachment mechanism. A baby lays upon and makes physical contact with the breathable fabric layer. In addition, air can easily pass through the breathable fabric layer, which allows a baby to be able to breathe through the breathable fabric layer. The air-permeable cushioning layer is used to support the breathable fabric layer offset from the top surface of a mattress so that a quantity of air can be retained in between the breathable fabric sheet and the top surface of the mattress. The bed-attachment mechanism is used to secure the breathable fabric layer and the air-permeable cushioning layer to a mattress. The bed-attachment mechanism is preferably made of a fabric material that is either polyester, cotton, or a combination thereof.

The general configuration of the aforementioned components allows the present invention effectively and efficiently prevent suffocation of a baby laying down on a mattress. The breathable fabric layer is superimposed across the air-permeable cushioning layer so that the breathable fabric layer acts as a tactilely-pleasant barrier between a baby's skin and the air-permeable cushion layer. In addition, the breathable fabric layer and the air-permeable cushioning layer is coextensive with each other so that the bed-attachment mechanism can be perimetrically connected around both the air-permeable cushioning layer and the air-permeable cushioning layer. In the preferred embodiment, the breathable fabric layer and the air-permeable cushioning layer are perimetrically connected to each other in order to form a three-way connection intersection between the breathable fabric layer, the air-permeable cushioning layer, and the bed-attachment mechanism.

The breathable fabric layer may comprise a layer body and a plurality of holes or a woven structure which allows air to easily pass through it. The plurality of holes traverses through the layer body and is uniformly distributed across the layer body so that a baby is able to breathe through any specific section of the breathable fabric layer.

The air-permeable cushioning layer may comprise a plurality of elastic filaments, which are woven into a three-dimensional spring structure. This configuration for the plurality of elastic filaments allows the air-permeable cushioning layer to maintain its elastic compressibility and to retain a quantity of air within empty spaces formed amongst the plurality of elastic filaments. Moreover, the plurality of elastic filaments is made of a quantity of thermoplastic elastomer, which is preferably a material combination of polyester and polyether. The polyester provides the quantity of thermoplastic elastomer with a harder element, while the polyether provides the quantity of thermoplastic elastomer with a softer element. In addition, a thickness of the air-permeable cushion layer is in a range of 0.1 inches to 5 inches. However, this range is only an approximate thickness of the air-permeable cushion layer.

In one embodiment, the bed-attachment mechanism is a skirt that is preferably used to secure the present invention to a crib mattress. The skirt comprises a free looping edge and a fixed looping edge, which are positioned opposite to each other across the skirt. The fixed looping edge is perimetrically connected around the breathable fabric layer and the air-permeable cushioning layer so that the free looping edge is able to drape the skirt over the lateral surface of a mattress. In addition, this embodiment may further comprise an elastic liner that is connected along the free looping edge. The elastic liner allows this embodiment of the present invention to be secured to a mattress in the same manner a fitted sheet is secured to a mattress.

In another embodiment, the bed-attachment mechanism is an enveloping pouch that is preferably used to secure the present invention to a bassinet mattress. The enveloping pouch comprises a pouch body and an access slit. An outer lateral edge of the pouch body is perimetrically connected to the breathable fabric layer and the air-permeable cushioning layer, which allows a mattress to be completely enclosed in between the enveloping pouch and the other components of the present invention. The access slit traverses through the pouch body so that a mattress can be inserted into or removed out of the present invention. Moreover, this embodiment of the present invention may further comprise a fastener. The fastener comprises at least one first interlocking element and at least one second interlocking element, which are used to open and close the access slit. The first interlocking element and the second interlocking element can be, but is not limited to, zipper connection pieces, magnets, snaps, hook-and-loop pieces, and buttons. Thus, the first interlocking element needs to be connected onto the pouch body, adjacent to the access slit, and the second interlocking element needs to be connected onto the pouch body, adjacent to the access slit. This arrangement allows the first interlocking element and the second interlocking element to be positioned opposite to each other across the access slit and consequently allows the access slit to be open or closed by selectively disengaging or engaging the first interlocking element and the second interlocking element.

### Alternative Description:

The subject of the invention is a sewn fitted sheet for an infant crib mattress or bassinet mattress with improved breathability for the baby.

The top layer of the sheet has a breathable fabric layer with a pattern of holes to allow the baby to breath freely, even when their face is lying against the surface of the fabric.

Below the top layer is a second layer of woven mesh that is constructed in 3 dimensions to create an open layer that allows air to easily pass through with additional space for the baby to breath without the obstruction of any air flow.

The overall construction of the fitted sheet is done so that the sheet will assemble to a standard crib mattress or standard bassinet mattress in the same fashion as any traditional fitted sheet. Once assembled to the mattress this sheet will allow for an unobstructed flow of air for any baby that lies on the surface of the mattress.

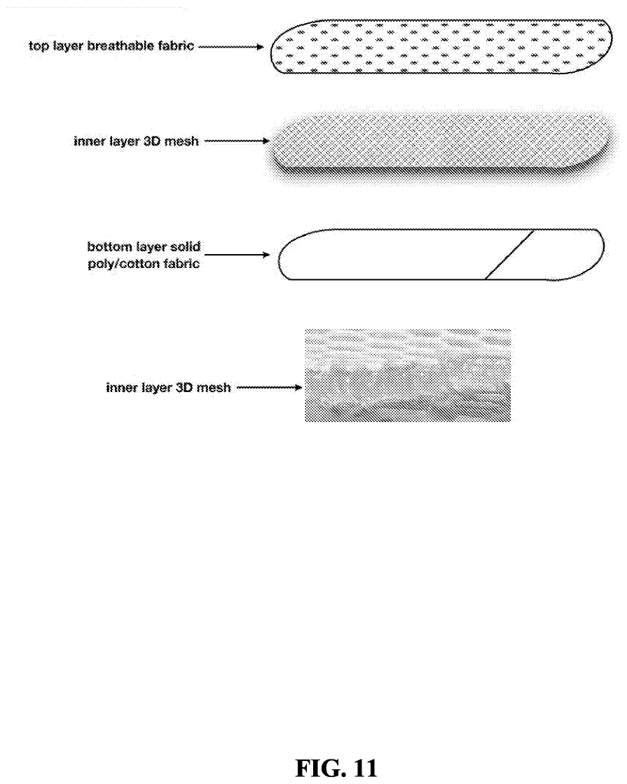

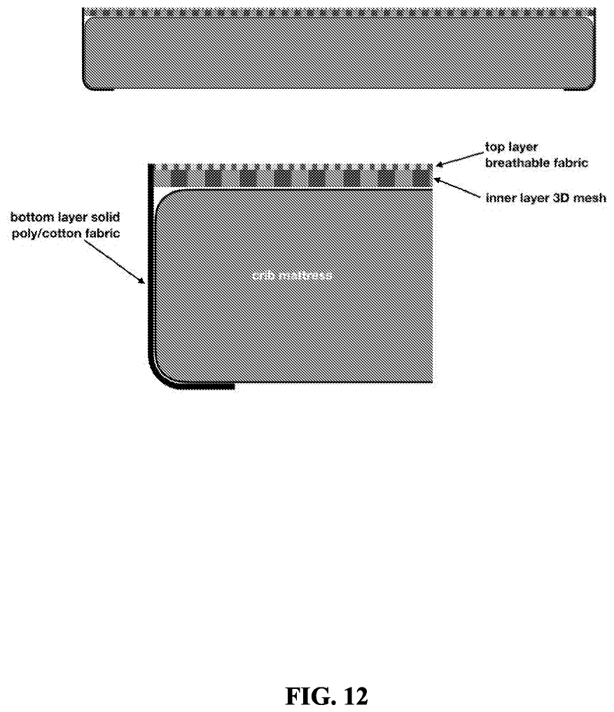

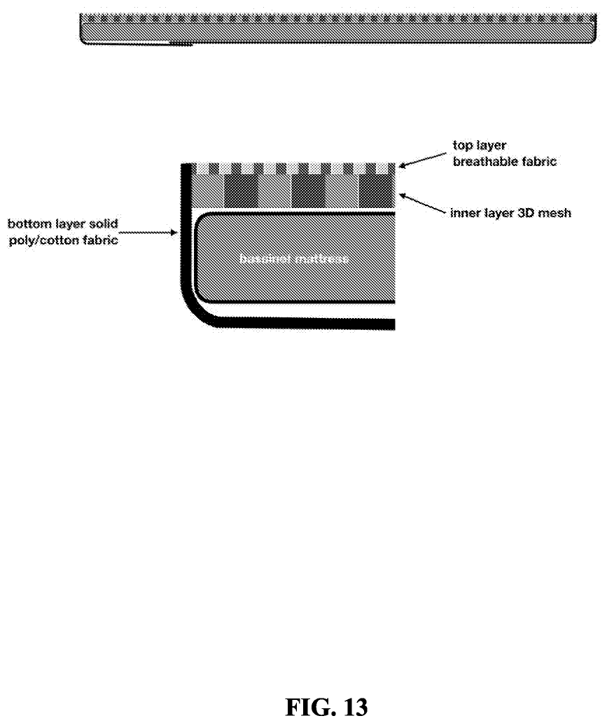

As shown in FIG. 11, the present invention consists of a top layer breathable fabric with a pattern of holes, an inner layer 3D mesh and a bottom layer solid poly/cotton fabric. As shown in FIG. 12 and FIG. 13, the crib or bassinet mattress is covered on top by a top layer breathable fabric and an inner layer 3D mesh and on the bottom by a layer a solid poly/cotton fabric.

This is for a “breathable” fitted sheet that is assembled to a mattress for a crib or bassinet or any sleeping devise. It is primarily used for babies, but it is also possible to use this invention on an adult sleeping surface (although this is not the main focus).

The reason for the breathable surface is two fold: 1.) So babies who may roll over and be face down on the sheet will be able to breath. When their nose and mouth is pushed to the sheet, their breathing will not be obstructed; and 2.) the layer of air under the child will allow the air flow to keep them cooler than if there were no air passing. underneath them. This helps keep babies comfortable and reduces the risk of over heating.

You should note that there are other breathable surfaces currently on the market that use similar materials as this invention. In some cases, companies have made fully breathable mattresses. These mattresses are comprised of a hollow frame with a layer of material stretched over the frame that has a hole pattern for breathability. In other cases, there are breathable mattress liners that are a single layer of 3-D mesh with a top layer of fabric with holes in it, so that when a baby is on top of it, it has the same breathable characteristics.

Both of these directions are not as unique or as effective as my invention, because they both do not work if a fitted sheet is placed over them. When you put a standard fitted sheet on top of these devises they lose their breathable qualities. If you do not use a fitted sheet they are subject to soiling by the baby if their diaper leaks or if they spit up. These items are not machine washable, so clean up is very difficult. Additionally with the breathable mattress, the messes may drip through the mattress and onto the floor.

In addition, it is very common to place a waterproof mattress liner on top of a crib mattress to protect it from the leaking mentioned above. If a waterproof liner is placed on top of the breathable products listed above they will no longer operate as designed, since the breathable layer will now be blocked.

The unique fashion of my invention is that because the breathable material is sewn into a fitted sheet, it can be placed

on any mattress (traditional and breathable) and it will still work. It can be placed over a waterproof liner and it will still work. Since it is the sheet, it can be placed over anything and it will still work. Additionally since it is fully machine washable, it can be soiled by the baby and easily cleaned up for re-use.

Although the invention has been explained in relation to its preferred embodiment, it is to be understood that many other possible modifications and variations can be made without departing from the spirit and scope of the invention as hereinafter claimed.

What is claimed is:

1. A breathable bed cover comprises:
a breathable fabric layer;
an air-permeable cushioning layer;
a bed-attachment mechanism;
the breathable fabric layer being superimposed across the air-permeable cushioning layer;
the breathable fabric layer and the air-permeable cushioning layer being coextensive with each other; and
the bed-attachment mechanism being perimetrically connected around the breathable fabric layer and the air-permeable cushioning layer.

2. The breathable bed cover as claimed in claim 1 comprises:
the breathable fabric layer and the air-permeable cushioning layer being perimetrically connected to each other.

3. The breathable bed cover as claimed in claim 1 comprises:
the breathable fabric layer comprises a layer body and a plurality of holes;
the plurality of holes traversing through the layer body; and
the plurality of holes being uniformly distributed across the layer body.

4. The breathable bed cover as claimed in claim 1 comprises:
the air-permeable cushioning layer comprises a plurality of elastic filaments; and
the plurality of elastic filaments being woven into a three-dimensional spring structure.

5. The breathable bed cover as claimed in claim 4 comprises:
the plurality of elastic filaments being made of a quantity of thermoplastic elastomer.

6. The breathable bed cover as claimed in claim 5 comprises:
the quantity of thermoplastic elastomer being a material combination of polyester and polyether.

7. The breathable bed cover as claimed in claim 1 comprises:
a thickness of the air-permeable cushioning layer being is in a range between 0.1 inches to 05. inches.

8. The breathable bed cover as claimed in claim 1 comprises:
the bed-attachment mechanism being a skirt;
the skirt comprises a free looping edge and a fixed looping edge;
the free looping edge and the fixed looping edge being positioned opposite of each other across the skirt; and
the fixed looping edge being perimetrically connected around the breathable fabric layer and the air-permeable cushioning layer.

9. The breathable bed cover as claimed in claim 8 comprises:
an elastic liner; and
the elastic liner being connected along the free looping edge.

10. The breathable bed cover as claimed in claim 1 comprises:
the bed-attachment mechanism being an enveloping pouch;
the enveloping pouch comprises a pouch body and an access slit;
the pouch body comprises an outer lateral edge;
the outer lateral edge being perimetrically connected around the breathable fabric layer and the air-permeable cushioning layer; and
the access slit traversing through the pouch body.

11. The breathable bed cover as claimed in claim 10 comprises:
a fastener;
the fastener comprises at least one first interlocking element and at least one second interlocking element;
the first interlocking element being connected onto the pouch body, adjacent to the access slit;
the second interlocking element being connected onto the pouch body, adjacent to the access slit; and
the first interlocking element and the second interlocking element being positioned adjacent to each other across the access slit.

12. The breathable bed cover as claimed in claim 1 comprises:
the bed-attachment mechanism being made of a fabric material selected from a group consisting of: polyester, cotton, and a combination thereof.
